(19) United States
(12) Patent Application Publication
(10) Pub. No.: US 2014/0136487 A1
(43) Pub. Date: May 15, 2014

(54) CONTENT MANAGEMENT TARGETED ROLLBACK

(71) Applicant: INTERNATIONAL BUSINESS MACHINES CORPORATION, Armonk, NY (US)

(72) Inventors: Randy E. Oyarzabal, Rochester, MN (US); Jeffery A. Turner, Lexington, KY (US)

(73) Assignee: INTERNATIONAL BUSINESS MACHINES CORPORATION, Armonk, NY (US)

(21) Appl. No.: 13/676,635

(22) Filed: Nov. 14, 2012

(51) Int. Cl. G06F 17/30

(52) U.S. Cl. 707/684; 707/E17.008

(57) ABSTRACT

A computer-implemented system and method for content management targeted rollback, including receiving at least one change to be made to a field on a document. A rollback document representing the document is stored. Metadata associated with the change and the rollback document is stored. The change is executed. A rollback request is received containing targeting metadata designating the rollback document. The document is rolled back to the rollback document that is associated with the stored metadata that corresponds to the targeting metadata.

### BACKGROUND

1. Field

This disclosure relates generally to data processing, file management and databases, and, more particularly, to transaction logging, log recovery and recovery of data.

2. Background

Mass changes to database records is a common business task. Erroneous updates and changes are sometimes made to database records. Should this occur, backups are typically accessed to restore database records to a previous state extant before the update was applied. This restoration process can be a cumbersome and time consuming process, particularly for those applications where targeted document restores are not available.

### BRIEF SUMMARY

In one aspect of this disclosure, a computer-implemented method for content management targeted rollback is disclosed, comprising receiving at least one change to be made to a field on a document. A rollback document representing the document is stored. Metadata associated with the change and the rollback document is stored. The change is executed. A rollback request is received containing targeting metadata designating the rollback document. The document is rolled back to the rollback document that is associated with the stored metadata that corresponds to the targeting metadata.

In another aspect of this disclosure, a computer-implemented system for content management targeted rollback is disclosed, comprising a processor, and computer memory, the computer memory comprising program instructions executable by the processor to receive at least one change to be made to a field on a document. A rollback document representing the document is stored. Metadata associated with the change and the rollback document is stored. The change is executed. A rollback request is received containing targeting metadata designating the rollback document. The document is rolled back to the rollback document that is associated with the stored metadata that corresponds to the targeting metadata.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 is a high level representation of an illustrative content management targeted rollback system supporting a database;

FIG. 2 is a high level representation of the relationship between journaled updates and various forms of metadata that may be associated with each journaled update;

FIG. 3 is an illustrative sequence of steps for implementing a first variation of journaling updates and related metadata;

FIG. 4 is an illustrative sequence of steps for implementing a second variation of journaling updates and related metadata;

FIG. 5 is an illustrative sequence of steps for implementing a third variation of journaling updates and related metadata; and

FIG. 6 is an illustrative sequence of steps for implementing targeted rollback based on received target metadata.

### DETAILED DESCRIPTION

This application discloses a content management targeted rollback system and method. The content management targeted rollback system and method allows the creation of a separate application for handling the journaling of records before changes are made. Records may be stored within a number of discrete documents, each document having any number of information fields. Different strategies may be used to journal updates to the documents or fields, depending on the needs of the end user.

For example, in a first strategy for journaling updates, full documents may be journaled as they are updated, capturing information in all document fields, regardless of whether each field was actually updated. This makes rolling back updates on documents easy, as it requires only a swap of the current document for the journaled version of the document. However, it requires large amounts of storage capacity, because of the capture of much extraneous data in the form of non-updated fields.

In a second strategy for journaling updates, documents may be selected for journaling, but only updated fields are journaled. Rolling back updates becomes more processor intensive, but storage capacity requirements are reduced due to the excision of unnecessary data.

In a third strategy for journaling updates, specific fields may be selected for journaling, and only updates to the selected fields are journaled. Rolling back updates under such a scheme is the most processor intensive, relative to the first two strategies. However, storage capacity is also minimal, as only desired updates are retained. There is also a risk of missing the capture of update data, if a field is erroneously unselected for journaling.

When an update occurs, the current version of the to-be-updated document or field is stored according to one of the above storage strategies. In addition, associated metadata is stored with the current version. Associated metadata may include information such as (but is not limited to) the identity of the individual who initiated the update, timestamps for the update, data sources and destinations for the update, and any other information that may be pertinent to the update. For example, an indicator metadata element may identity attached data as new data, aiding in rollback data identification, auditing and reporting. Similarly, a metadata may be attached that indicates a reason for a change or update of the data.

When an update is to be rolled back to a past version, a user may be presented with the full range of past versions for any particular document or field. The desired past version may be selected by specifying metadata associated with the past version at the time of the update. For example, the user may know that the update was initiated by a particular individual at a particular time. By specifying the identifier metadata and timestamp metadata, the user may therefore designate the desired past version to be restored.

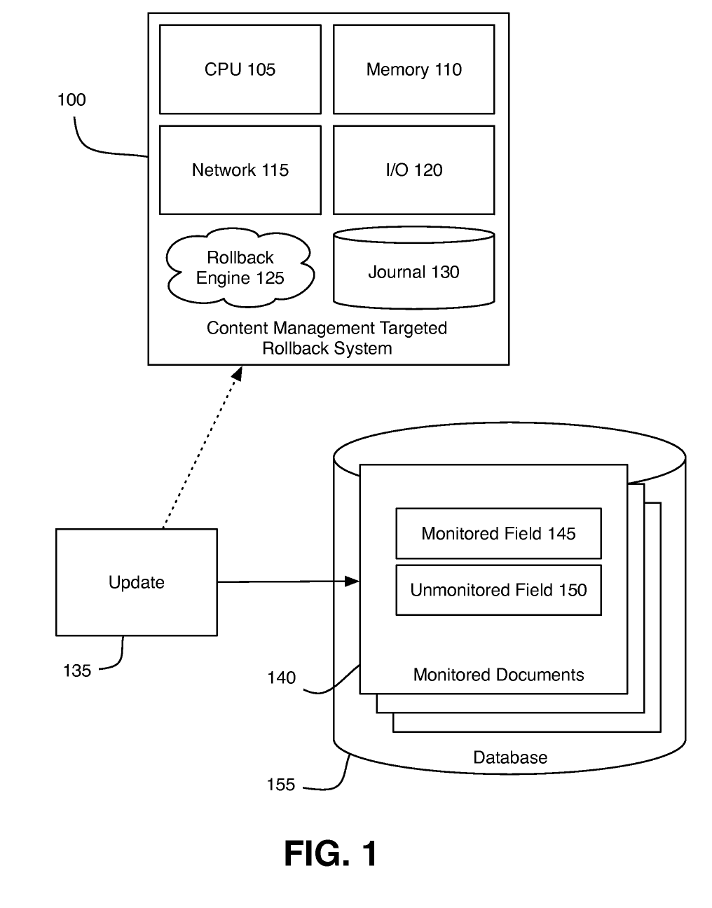

FIG. 1 is a high level representation of an illustrative content management targeted rollback system 100 supporting a database 155. The targeted rollback system 100 may comprise a central processing unit (“CPU”) 105, a memory device 110, a network device 115 and an input/output device 120. The CPU 105 may receive and execute program instructions. The memory device 110 may provide both long term and short-term storage for the CPU 105, and represent devices such as a cache, random access memory, hard drive, optical storage, etc. The network device 115 may provide the targeted rollback system 100 with access to a computer network, such as a local area network, or the Internet. The input/output device 120 enables user interaction with the targeted rollback system 100, and may therefore include devices such as computerized displays, keyboard, mouse, and other computer input and output devices.

A rollback engine 125 operates on the targeted rollback system 100. The rollback engine 125 is responsible for both receiving update operations 135 and journaling them with associated metadata, as well as receiving rollback requests and executing the resulting rollback operations. A journal 130 is a data store for the update operations 135, past versions of monitored documents 140 and/or monitored fields 145, and associated metadata. The journal 130 may be implemented within the memory device 110 (such as a database operating in random access memory), or it may be implemented on a separate and independent memory device.

Updates 135 are data operations that alter or update data extant on the database 155. Updates 135 may be received from any number of data sources, including user-generated updates, or updates generated from external processes, information flows, system operations, etc. The database 155 stores a plurality of monitored documents or data records 140, each of which contain a number of sub-fields. In embodiments implementing the third storage strategy described above, the sub-fields may be divided into monitored fields 145 and unmonitored fields 150.

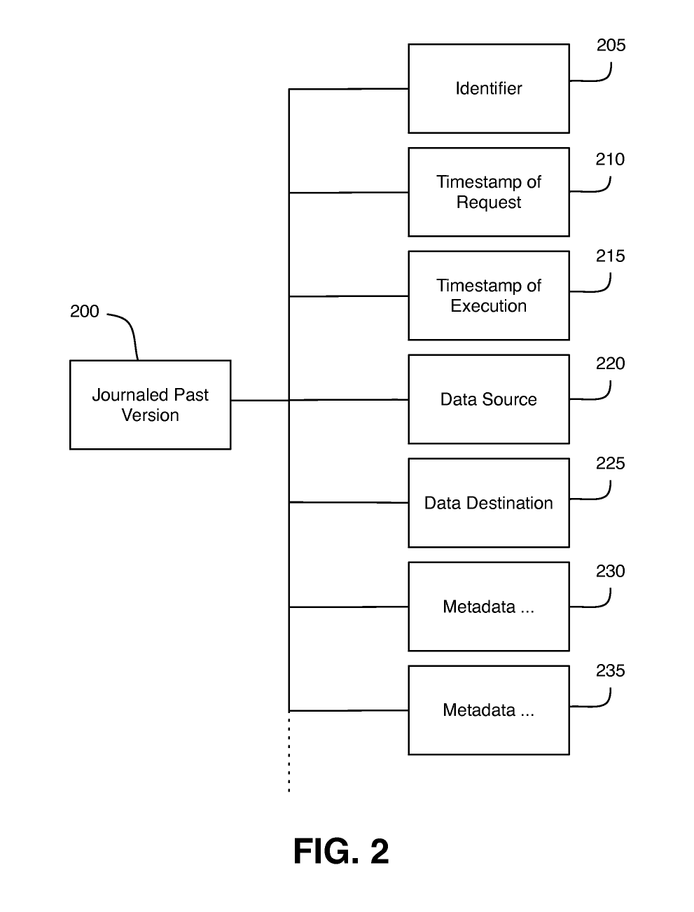

FIG. 2 is a high level representation of the relationship between journaled past versions 200 and various forms of metadata 205-235 that may be associated with each journaled past version 200. As described above, when updates arrive, the targeted rollback system 100 may journal the pre-update version of the to-be-changed field or document as a past version 200. The updates 135 may arrive with a set of associated metadata, including information such as an identifier identifying the user that promulgated the update, timestamps, data sources and destinations, etc. When the past version 200 is journaled, the metadata associated with the update 135 that triggered the journaling may be stored alongside the past version 200 in the journal 130. Therefore, each journaled past version 200 may be associated with a plurality of metadata 205-235. An identifier 205 metadata may specify the originating user that promulgated the update. A timestamp of request 210 metadata may mark the time in which the update 135 was requested. A timestamp of execution 215 metadata may mark the time in which the update 135 was executed on the document 140 or monitored field 145. A data source 220 metadata may indicate the source from which the data comprising the update 135 originated. A data destination 225 may designate the system or database to which the update 135 was directed towards (and may be very useful in a situation where the targeted rollback system 100 is monitoring multiple databases). The possible associated metadata types are not limited to the metadata enumerated upon here. Other metadata 230-235 may be added as necessary or desirable by the end user.

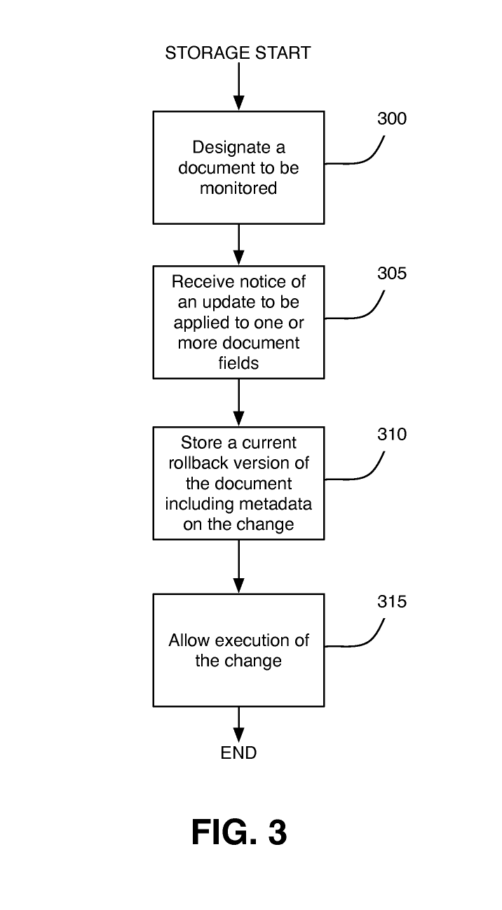

FIG. 3 is an illustrative sequence of steps for implementing the first strategy of journaling past versions 200 and related metadata 205-235, wherein full documents, including all sub-fields, regardless of whether they have been updated, are journaled. A user may designate to the targeted rollback system 100 a document 140 to be monitored and journaled (step 300). If back ups required journaling of the entire database each time an update 135 was received, the targeted rollback system 100 would have enormous storage capacity requirements. Therefore, only specific documents should be designated for journaling to save storage capacity for critical documents and records.

The targeted rollback system 100 may then await a notice of an impending update 135 to the monitored document 140 (step 305). Update 135 notices may be received by the targeted rollback system 100 in a plurality of ways. In one embodiment, the database 155 may send a notice of the update 135 to the targeted rollback system 100. Alternatively, the targeted rollback system 100 may be interposed between the database 155 and external sources from which updates 135 may originate, and monitor network traffic to the database 155. Any strategy may be utilized to ensure that notices of updates 135 are received by the targeted rollback system 100.

Once notice of an update 135 related to a monitored document 140 is received (step 305), the rollback engine 125 may store in the journal 130 a current pre-update version 200 of the monitored document 140 (step 310), including metadata associated with the update 135. The past version 200 may be obtained from the database 155 in any manner. For example, the rollback engine 125 may request the relevant current pre-update version of the monitored document 140 from the database 155, and store it in the journal 130. Finally, the targeted rollback system 100 may allow execution of the update 135 on the monitored document 140 on database 155 (step 315). This may be executed by sending a release indicator to the database 155 allowing promulgation of the update 135.

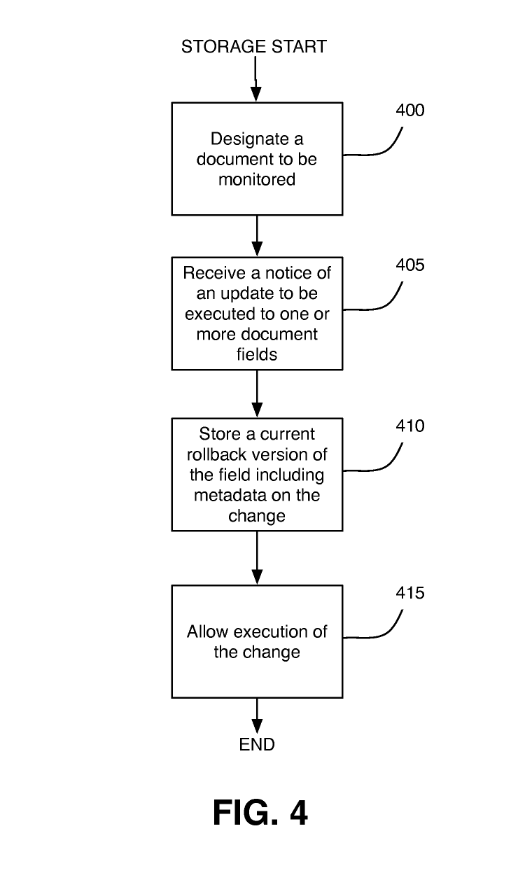

FIG. 4 is an illustrative sequence of steps for implementing a second variation of journaling past versions 135 and related metadata 205-235, where only updated fields on designated monitored documents 140 are stored. This strategy advantageously reduces the storage capacity requirement of the targeted rollback system 100, as only updated fields are stored in memory, rather than full documents including both modified and unmodified fields. As with the first strategy, a document 140 is specified for monitoring by the targeted rollback system 100 (step 400). An update 135 may be received by the database 155, whereupon a notice of the update 135 may be published to the targeted rollback system 100 (step 405). The targeted rollback system 100 may then store current pre-update versions of fields affected by the update 135 in the journal 130 (step 410), including metadata associated with the update 135. The targeted rollback system 100 then allows promulgation of the update 135 on the database 155 (step 415).

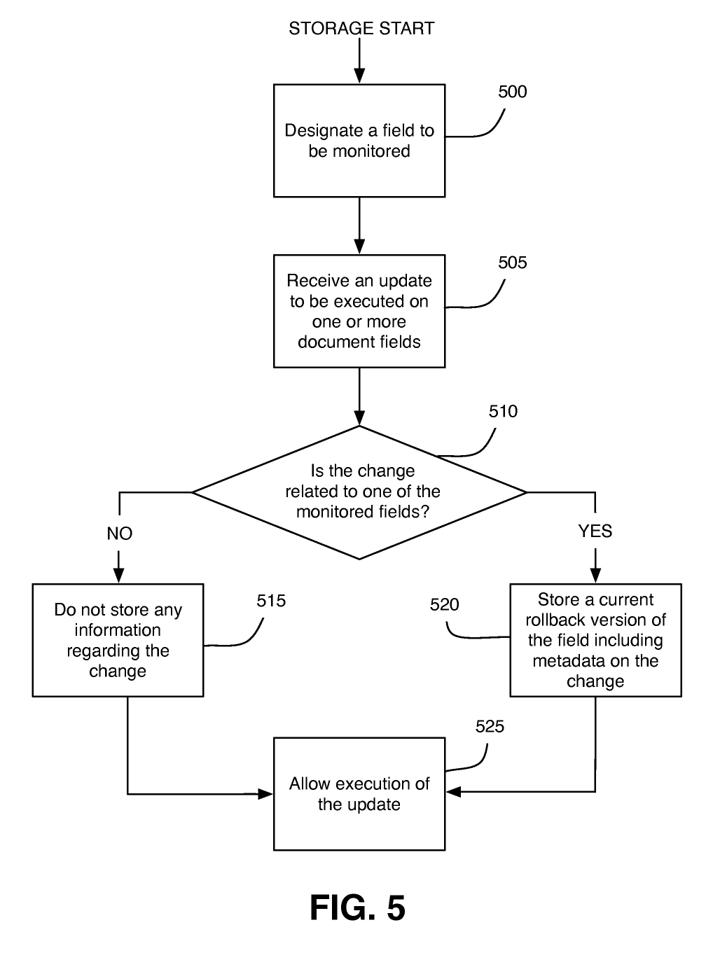

FIG. 5 is an illustrative sequence of steps for implementing a third variation of journaling updates 135 and related metadata 205-235, where only current pre-update versions of monitored fields 145 are journaled by the targeted rollback system 100. Instead of designating particular documents to be monitored, specific fields 145 are designated for monitoring (step 500). Subsequently, a notice of an update 135 is received by the targeted rollback system 100 (step 505). The targeted rollback system 100 then determines whether the update 135 is related or applicable to any of the monitored fields 145. If the update 135 is not applicable to any of the monitored fields 145, then no information is stored in the journal 130 related to the update 135 (step 515), and the targeted rollback system 100 issues a notice to the database 155 allowing promulgation of the update 135 (step 525). If the targeted rollback system 100 determines that the update 135 is applicable to one or more monitored fields 145, then a current pre-update version of the monitored field or fields 145 is stored in the journal 130 (step 520), including metadata related to the update 135, and the update 135 is allowed to promulgate on the database 155 (step 525).

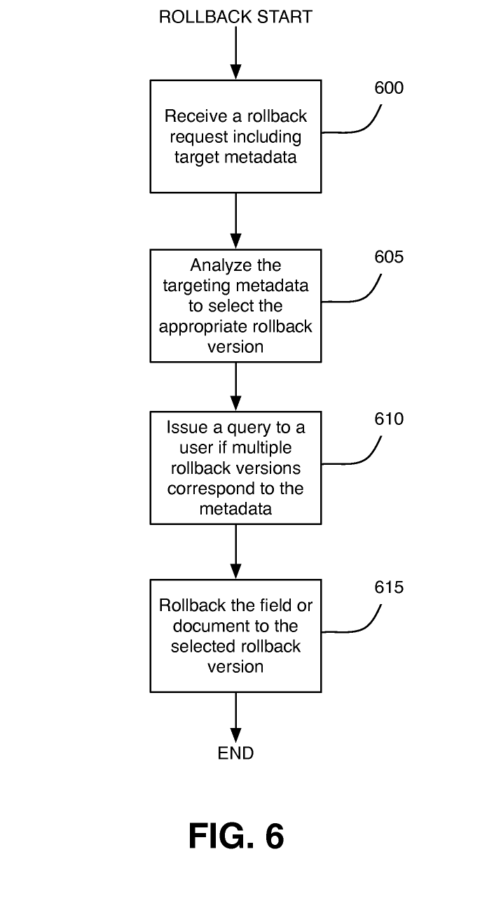

FIG. 6 is an illustrative sequence of steps for implementing targeted rollback based on stored target metadata. The targeted rollback system 100 receives a request to rollback an update 135 (step 600), including associated target metadata that may be used by the targeted rollback system 100 to determine which past version of the document 140 or field 145 is appropriate. For example, the targeted rollback system 100 may receive a request to rollback a field “A,” in document “B,” wherein the update 135 was associated with an identifier 205 specifying “A. Smith,” with a timestamp 215 of “1:00PM 9/3/12.” The targeted rollback system 100 may then retrieve from the journal 130 all journaled past versions of field “A” in document “B,” and analyze the associated targeting metadata stored with those retrieved past versions, to select the particular past versions having an identifier 205 specifying “A. Smith” with a timestamp 215 of “1:00PM 9/3/12” (step 605). If there are multiple matches, a query may be issued to a user requesting the rollback asking the user to select from the set of possible matches (step 610). Finally, the selected past version may be promulgated to the database 155, rolling back field “A” of document “B” to the version extant immediately before the update 135 was executed on the database 155 (step 615).

The collection of large quantities of historical information on updates 135, past versions 200 and various types of metadata 205-235 can be advantageously leveraged in a plurality of ways. For example, the body of information may be used for auditing purposes, helping a user determine the efficacy of one or more updates, aided by the body of metadata 205-235, and the propensity of a certain type of update to cause problems (indicated by a large number of rollbacks) within the database 155.

Aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, can be implemented by computer instructions. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks.

The aforementioned programs can be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware (not shown).

The foregoing description of various embodiments of the present invention has been presented for purposes of illustration and description. It is not intended to be exhaustive nor to limit the invention to the precise form disclosed. Many modifications and variations are possible. Such modifications and variations that may be apparent to a person skilled in the art of the invention are intended to be included within the scope of the invention as defined by the appended claims.

What is claimed is:

1. A computer-implemented method for content management targeted rollback, comprising:
receiving, using a computer processor, at least one change to be made to a field on a document;
storing, using computer memory, a rollback document representing the document prior to the execution of the change;
storing, using the computer memory, metadata associated with the change and the rollback document;
executing, using the computer processor, the change;
receiving, using the computer processor, a rollback request containing targeting metadata designating the rollback document; and
rolling back, using the computer processor, the document to the rollback document that is associated with the stored metadata that corresponds to the targeting metadata.

2. The method of claim 1, further comprising:
storing as the metadata at least an identification of the individual making the change, a timestamp for the change, an error check for the change, a data source of the change, or a data destination of the change.

3. The method of claim 1, wherein a plurality of rollback documents have associated stored metadata corresponding to the targeting metadata, the method further comprising:
receiving a selection indicating one of the plurality of rollback documents to utilize in response to the rollback request.

4. A computer-implemented method for content management targeted rollback, comprising:
receiving, using a computer processor, at least one change to be made to a field on a document;
storing, using computer memory, a rollback field representing the field prior to the execution of the change;
storing, using the computer memory, metadata associated with the change and the rollback field;
executing, using the computer processor, the change;
receiving, using the computer processor, a rollback request containing targeting metadata designating the rollback field; and
rolling back, using the computer processor, the document to the rollback field that is associated with the stored metadata that corresponds to the targeted metadata.

5. The computer-implemented method of claim 4, further comprising:
receiving an indicator designating at least one field to be monitored; and
storing the rollback field representing the field prior to the execution of the change only if the rollback request pertains to the at least one field.

6. The computer-implemented method of claim 4, further comprising:
storing as the metadata at least an identification of the individual making the change, a timestamp for the change, a error check for the change, a data source of the change, or a data destination of the change.

7. The computer-implemented method of claim 4, further comprising:
receiving the rollback request containing targeting metadata, wherein the targeting metadata designates a plurality of rollback fields.

8. The computer-implemented method of claim 4, wherein a plurality of rollback fields have associated stored metadata corresponding to the targeting metadata, the method further comprising:
receiving a selection indicating one of the plurality of rollback fields to utilize in response to the rollback request.

9. The computer implemented method of claim 5, further comprising:
receiving a second indicator designating another field to be monitored after rolling back the document to the rollback field.

10. The computer implemented method of claim 9, further comprising:
receiving a third indicator indicating that a monitored field should no longer be monitored.

11. A content management targeted rollback system, comprising:
a computer processor;
computer memory comprising program instructions, the program instructions executable by the processor to:
receive at least one change to be made to a field on a document;
store a rollback document representing the document prior to the execution of the change;
store metadata associated with the change and the rollback document;
execute the change;
receive a rollback request containing targeting metadata designating the rollback document; and
roll back the document to the rollback document that is associated with the stored metadata that corresponds to the targeting metadata.

12. The system of claim 11, the program instructions further executable by the processor to:
store as the metadata at least an identification of the individual making the change, a timestamp for the change, a error check for the change, a data source of the change, or a data destination of the change.

13. The system of claim 11, wherein a plurality of rollback documents have associated stored metadata corresponding to the targeting metadata, the program instructions further executable by the processor to:
receive a selection indicating one of the plurality of rollback documents to utilize in response to the rollback request.

14. A content management targeted rollback system, comprising:
a computer processor;
computer memory comprising program instructions, the program instructions executable by the processor to:
receive at least one change to be made to a field on a document;
store a rollback field representing the field prior to the execution of the change;
store metadata associated with the change and the rollback field;
execute the change;
receive a rollback request containing targeting metadata designating the rollback field; and
roll back the document to the rollback field that is associated with the stored metadata that corresponds to the targeted metadata.

15. The system of claim 14, the program instructions further executable by the processor to:
receive an indicator designating at least one field to be monitored; and
store the rollback field representing the field prior to the execution of the change only if the rollback request pertains to the at least one field.

16. The system of claim 14, the program instructions further executable by the processor to:
store as the metadata at least an identification of the individual making the change, a timestamp for the change, a error check for the change, a data source of the change, or a data destination of the change.

17. The system of claim 14, the program instructions further executable by the processor to:
receive the rollback request containing targeting metadata, wherein the targeting metadata designates a plurality of rollback fields.

18. The system of claim 14, wherein a plurality of rollback fields have associated stored metadata corresponding to the targeting metadata, the program instructions further executable by the processor to:
receive a selection indicating one of the plurality of rollback fields to utilize in response to the rollback request.

19. The system of claim 15, the program instructions further executable by the processor to:
receive a second indicator designating another field to be monitored after rolling back the document to the rollback field.

20. The system of claim 19, the program instructions further executable by the processor to:
receive a third indicator indicating that a monitored field should no longer be monitored.
